(19) United States
(12) Patent Application Publication
(10) Pub. No.: US 2006/0276996 A1
(43) Pub. Date: Dec. 7, 2006

(54) Fast tracking system and method for generalized LARS/LASSO

(76) Inventor: Sathiya Selvaraj Keerthi, South Pasadena, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/446,345

(22) Filed: Jun. 1, 2006

Related U.S. Application Data
(60) Provisional application No. 60/686,716, filed on Jun. 1, 2005.

(51) Int. Cl. G06F 17/18; G06F 19/00; G06F 15/00

(52) U.S. Cl. 702/179

(57) ABSTRACT

The present invention provides an efficient method for tracking the solution curve of sparse logistic regression with respect to the L₁ regularization parameter. The method is based on approximating the logistic regression loss by a piecewise quadratic function, using Rosset and Zhu's path-tracking algorithm on the approximate problem, and then applying a correction to obtain the true path.

### CROSS-REFERENCE TO RELATED APPLICATIONS

This application claims the benefit of U.S. provisional patent application No. 60/686,716, entitled “A Fast Track Algorithm For Generalized LARS/LASSO,” filed Jun. 1, 2005, which is herein incorporated by reference in its entirety.

### FIELD OF THE INVENTION

A system and method provides a fast tracking system and method for generalized LARS/LASSO. More specifically, a system and method approximates the logistic regression loss by a piece-wise quadratic function, tracks the piecewise linear solution curve corresponding to it, and applies a correction step to get to the true path.

### BACKGROUND OF THE INVENTION

In many applications for classifying a web page as being one type or another, each example (web page) is represented as a vector of a large number of features. For instance, the presence or absence of a word can be used to form a feature. If all the words in a corpus are considered as possible features, then there can be millions of features. An even larger number of features is possible if pairs or more general combinations of words or phrases are considered.

For improved classification speed during runtime, it would be desirable to remove unwanted features. In web-page classification problems, the presence of unwanted features can also harm the performance of the classifier.

Accordingly, those skilled in the art have long recognized the need for a system and method to assist in feature removal for classifiers built using logistic regression. This invention clearly addresses this and other needs.

### SUMMARY OF THE INVENTION

Briefly, and in general terms, various embodiments are directed to a system and method for tracking the solution curve of sparse logistic regression that can be used, for example, and not by way of limitation, to classify text documents, such as web page documents to be classified for an internet search engine. The method is based on approximating the logistic regression loss by a piece-wise quadratic function, tracking the piecewise linear solution curve corresponding to it, and then applying a correction step to get to the true path. In one preferred embodiment, the tracking of the solution curve uses Rosset and Zhu's path tracking method. In another preferred embodiment, the tracking algorithm is applied to kernel logistic regression. In yet another preferred embodiment, correction algorithm comprises a pseudo-Newton correction process.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a block diagram illustrating components of a search engine in which one embodiment operates;

FIG. 2 is an example of a news web page that can be categorized using one embodiment;

FIG. 3 is a flow diagram illustrating steps performed by the system according to one embodiment;

FIG. 4 is a graph illustrating corresponding parameters and approximations that are derived from a method of one embodiment; and

FIG. 5 is a flow diagram illustrating steps of a tracking method performed by one embodiment.

### DETAILED DESCRIPTION

A system and method for tracking the solution curve of sparse logistic regression is described. The method is based on approximating the logistic regression loss by a piece-wise quadratic function, tracking the piecewise linear solution curve corresponding to it, and then applying a correction step to get to the true path.

A preferred embodiment of a fast tracking system and method for generalized LARS/LASSO, constructed in accordance with the claimed invention, provides an efficient algorithm for tracking the solution curve of sparse logistic regression with respect to the L₁ regularization parameter. The method is based on approximating the logistic regression loss by a piecewise quadratic function, using Rosset and Zhu's known path tracking method on the approximate problem, and then applying a correction to get to a true path. Rosset and Zhu derived a general characterization of the properties of loss L, penalty J pairs that give piecewise linear coefficient paths. Such pairs allow for efficient generation of the full regularized coefficient paths.

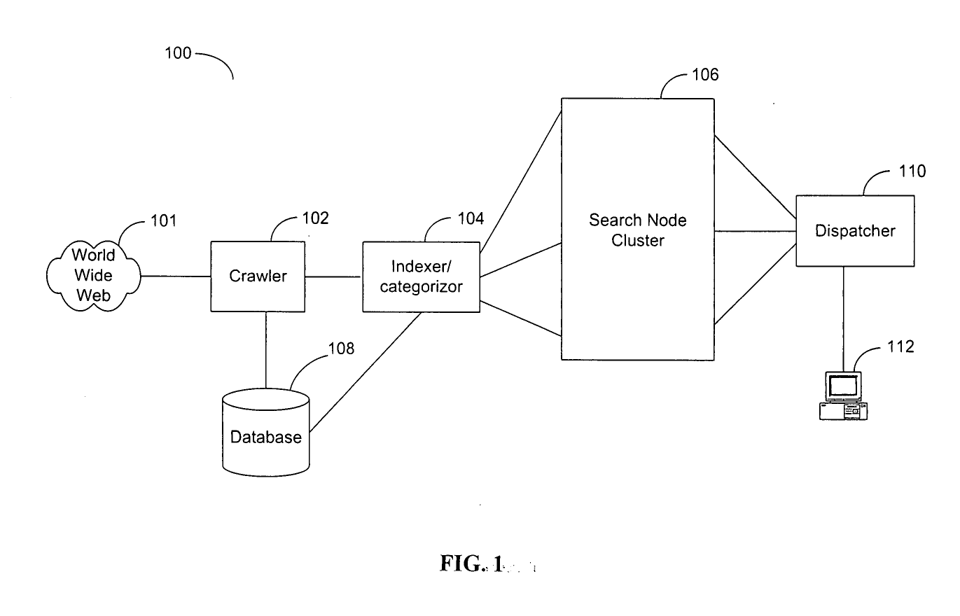

In one embodiment, as an example, and not by way of limitation, an improvement in Internet search engine labeling of web pages is provided. The World Wide Web is a distributed database comprising billions of data records accessible through the Internet. Search engines are commonly used to search the information available on computer networks, such as the World Wide Web, to enable users to locate data records of interest. A search engine system 100 is shown in FIG. 1. Web pages, hypertext documents, and other data records from a source 101, accessible via the Internet or other network, are collected by a crawler 102. The crawler 102 collects data records from the source 101. For example, in one embodiment, the crawler 102 follows hyperlinks in a collected hypertext document to collect other data records. The data records retrieved by crawler 102 are stored in a database 108. Thereafter, these data records are indexed by an indexer 104. Indexer 104 builds a searchable index of the documents in database 108. Common prior art methods for indexing may include inverted files, vector spaces, suffix structures, and hybrids thereof. For example, each web page may be broken down into words and respective locations of each word on the page. The pages are then indexed by the words and their respective locations. A primary index of the whole database 108 is then broken down into a plurality of sub-indices and each sub-index is sent to a search node in a search node cluster 106.

To use search engine 100, a user 112 typically enters one or more search terms or keywords, which are sent to a dispatcher 110. Dispatcher 110 compiles a list of search nodes in cluster 106 to execute the query and forwards the query to those selected search nodes. The search nodes in search node cluster 106 search respective parts of the primary index produced by indexer 104 and return sorted search results along with a document identifier and a score to dispatcher 110. Dispatcher 110 merges the received results to produce a final result set displayed to user 112 sorted by relevance scores.

As a part of the indexing process, or for other reasons, most search engine companies have a frequent need to classify web pages as belonging to one “group” or another. For example, a search engine company may find it useful to determine if a web page is of a commercial nature (selling products or services), or not. As another example, it may be helpful to determine if a web page contains a news article about finance or another subject, or whether a web page is spam related or not. Such web page classification problems are binary classification problems (x versus not x). Classification usually involves processing unwanted features that can severely slow classification, making such classification unsuited to real-time application.

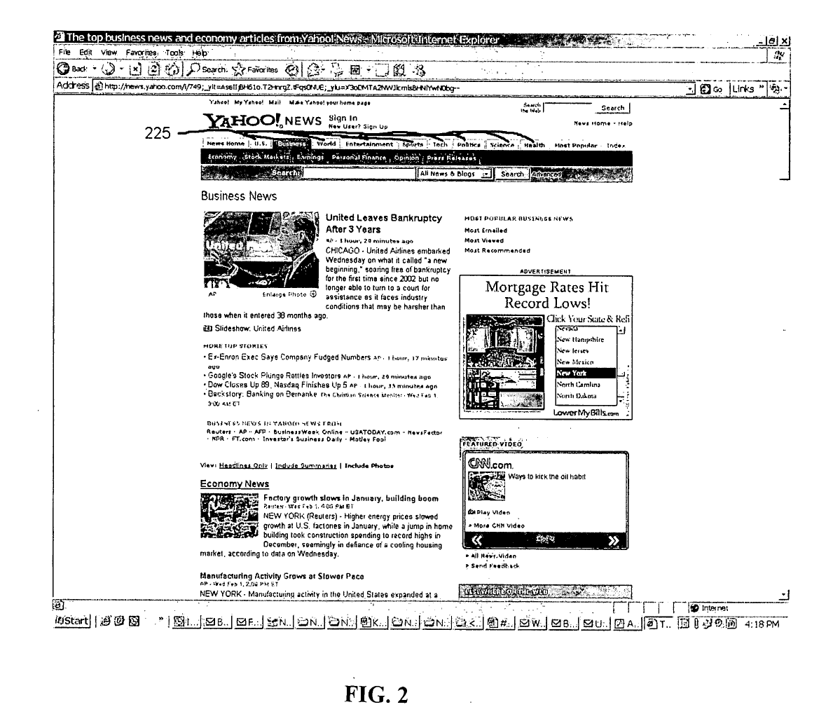

Referring to FIG. 2, there is shown an example of a web page that has been classified, or categorized. In this example, the web page is categorized as a “Business” related web page, as indicated by the topic indicator 225 at the top of the page. Other category indicators 225 are shown. Thus, if a user had searched for business categorized web pages, then the web page of FIG. 2 would be listed, having been categorized as such.

Considering a binary classification problem with parameter vector β ∈ R^{m} and training set {(xᵢ,tᵢ)}ᵢ₌₁ⁿ where: xᵢ ∈ R^{m} is the input vector of the i-th training example and tᵢ is the corresponding target taking values from {1, −1}. Using the linear model
γᵢ=β^{T}xᵢ (1)

and the probability function

$$P ( {t}_{i} \vert {x}_{i} ) = \frac{1}{1 + {ⅇ}^{- {r}_{i}}} ; \\ {r}_{i} = {t}_{i} {y}_{i} \qquad ( 2 )$$

the training problem corresponding to L₂-regularized logistic regression is

$${min}_{β} {f}_{0} ( β ) = \frac{μ}{2} {β}^{T} K β + {\sum }_{i = 1}^{n} l ( {r}_{i} ) \qquad ( 3 )$$

where l(r)=log(1+e^{-r}) is the logistic regression loss function and K is a symmetric positive semidefinite regularization matrix.

The logistic regression model given above has been typically used (usually with K=I where I is the identity matrix) in applications such as text categorization and gene selection for microarray data. Kernel logistic regression (KLR) is a useful tool for building nonlinear classifiers, and also can be used with the system and methods described herein. In KLR: m=n, xᵢⱼ=k(zᵢ, zⱼ), and Kᵢⱼ=k(zᵢ, zⱼ), where zᵢ, i=1, . . . ,n, are the original training input vectors, and k is the kernel function. The effect of the bias term can be brought about by adding a constant to the kernel function.

In all these noted methods, the number of coefficients in β is large and only a small fraction of them are sufficient for achieving the best possible classification accuracy. In one embodiment, the system and method described herein uses a sparse logistic regression, which is a modified model that is effective in the selection of a relevant subset of coefficients. The modification is done by including an L₁ regularizer:

$${min}_{β} {f}_{λ} ( β ) = {f}_{0} ( β ) + λ {‖ β ‖}_{1} \qquad ( 4 )$$

This formulation uses, both L₂ and L₁ regularizers, and is called as an elastic net model; sometimes there is value in keeping both regularizers. The well-known LASSO model can be used in an embodiment of equation 4 and corresponds to setting β=0. In equation 4, μ is taken to be a fixed value. The focus is on the tracking of the solution of equation 4 with respect to λ. When λ is large, β=0 is the minimizer of f_{λ}, which corresponds to the case of all coefficients being excluded. As λ is decreased, more and more coefficients take positive values. When λ→0, the solution of equation 4 approaches the minimizer of f₀, where all βᵢ are typically non-zero. Thus λ offers a useful way of obtaining sparse solutions.

Some fast algorithms are useful for solving equation 4. For example a cyclic coordinate descent method can be used. One variation of the iteratively reweighted least squares (IRLS) method can be used. These algorithms can be used to solve equation 4 for a given value of λ. When equation 4 is to be solved for several values of λ (for example, during the determination of λ by cross validation) these algorithms efficiently obtain the solutions by seeding (i.e., the β obtained at one λ is used to start-off the solution at the next nearby value of λ). However, they are not efficient enough if a fine tracking of solutions with respect to λ is needed.

There are reasons why it is useful to have an efficient algorithm that finely tracks the solution of equation 4 as a function of λ. First, together with cross validation, such tracking algorithm can be used to locate the best value of λ precisely. Second, coefficients and their effects on the solution of equation 4 can be determined. Third, many applications place a constraint on the number of non-zero coefficients. For example, in text categorization there may be a limit on the number of features that can be used in the final classifier for fast online processing. In KLR, for example, there may be a need to minimize the number of basis functions that define the classifier. Tracking offers a direct way of enforcing such constraints.

Thus, an efficient tracking algorithm that is nearly as efficient as the algorithms mentioned earlier is very useful. For least squares problems, tracking solutions with respect to the λ parameter has recently become very popular. For the LASSO model, it has been shown that the solution path in β space is piecewise linear and efficient algorithms for tracking this path have been provided. A LARS algorithm that nearly yields the same path as the LASSO algorithm has been derived. A whole range of problems for which the path is piecewise linear have been described. For example, the inventor of the system has used these methods to derive an effective algorithm for feature selection with linear SVMs. For logistic regression, the art regarding tracking of the solution path with respect to λ is very limited. Some rudimentary ideas for tracking have been developed. One simple algorithm was developed for tracking by starting with a large λ at which a β=0 is the solution, varying λ in ε decrements, and using the β at one λ to seed the solution at λ−ε. This method is slow and inadequate for large problems. In one system, predictor-corrector methods are considered (for a related kernel problem). These methods require repeated factorizations of the Hessian matrix, and so they are expensive for large number of coefficients.

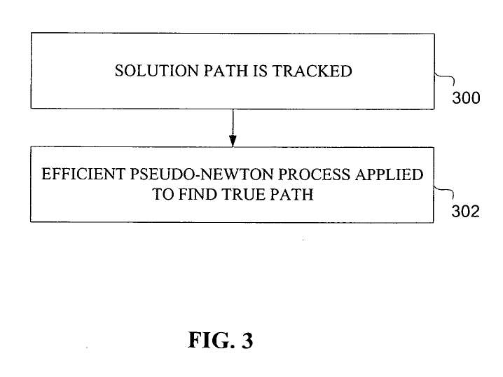

For the system and method described herein, an efficient method for tracking the solution of equation 4 has been derived with respect to λ by first tracking an approximate path and then using a pseudo-Newton correction process to get to the solution of equation 4. The system approximates the logistic regression loss function l in equation 3 by a suitable i that is non-negative, convex, differentiable and piecewise quadratic. This approximation is independent of the problem being solved and is only done once. With reference to FIG. 3, with such an i available, for a given problem, there are two main steps. In the first step 300, the solution path corresponding to i is tracked. In the second step 302, an efficient pseudo-Newton process is applied to proceed from the approximate path derived in step 300 to the true path corresponding to l.

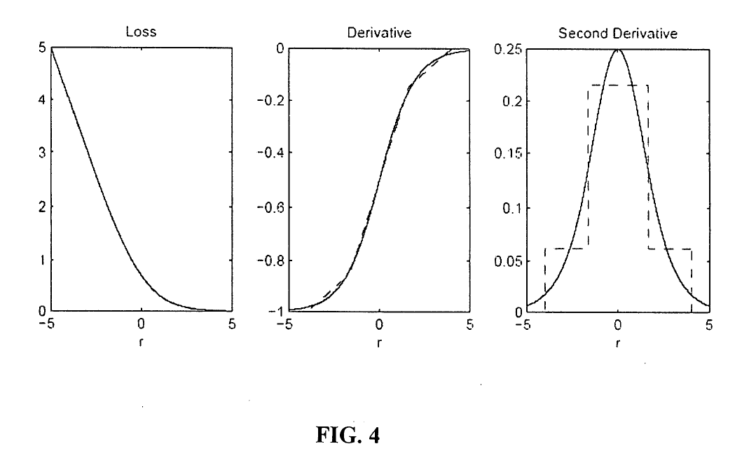

The approximate loss function i is formed by placing knot points on the r axis and choosing iⁿ to be a constant in each of the intervals defined by the knot points. FIG. 4 illustrates the approximation methods discussed below. Since iⁿ is symmetric about r=0, it is preferable in some embodiments to choose the knot points to be placed symmetrically about r=0. Thus, positive values can be selected, p₁<p₂< . . . <pₖ, and the knot points can be selected as {−pᵢ}ᵢ₌₁^{k} ∪{pᵢ}ᵢ₌₁^{k}, forming (2k+1) intervals in the r axis. (k+1) second derivative values can be selected, {aᵢ{ᵢ₌₀^{k} and iⁿ defined as: iⁿ(r)=a₀, if −p₁<r<p₁; and, for i≧1, iⁿ(r)=aᵢ, if −pᵢ₊₁<r≦−pᵢ or pᵢ≦r<pᵢ₊₁. In this embodiment, since i is convex, all aᵢ are non-negative. Integrating iⁿ twice produces i′ and i. This leads to two integration constants, which form additional variables. In one embodiment, to suit the logistic regression loss function, the following additional constraints can be enforced: aₖ=0; i′(0)=−0.5: i′(∞)=0; i′(−∞)=−1; and i(∞)=0 (this helps ensure that the loss function is a non-negative function). These constraints imply that, for r ∈ (−∞, −pₖ), iⁿ(r)=0, i′(r)=−1 and, for r ∈ (pₖ,∝), iⁿ(r)=0, i′(r)=0. Even after the above mentioned constraints are enforced, there is still freedom left in choosing the (pᵢ) and {aᵢ}. In one embodiment, since first derivatives play an important role in path tracking algorithms, it is preferable to resolve this freedom by making i′ as close as possible to i′ₜ, for example, by minimizing the integral of the square of the difference between the two functions. In one embodiment, this is an optimization method that is independent of the classification problem being solved. In one embodiment, it just needs to be solved once; then the optimized i can be used for all problems.

The value of k, which defines the approximation, is also selected. Although choosing k to be large will yield excellent approximations, it leads to inefficiencies in path tracking as discussed below. In one embodiment, k=2 is sufficient for all applications. The corresponding parameters and the approximations that are thus derived are shown in FIG. 4.

The approximate loss function can be compactly written as i(r)=½a(r)r²+b(r)r+c(r) where a(r), b(r) and c(r) are appropriately defined piecewise constant functions of r (and so their derivatives can be taken to be zero at non-knot points). a(r) is same as iⁿ and it plays a role in the tracking algorithm. b(r) plays a role in gradient calculations. For starting the method, the fact that b(0)=−0.5 is used, which derives from the constraint, i′(0)=−0.5 imposed earlier. For the rest of the algorithm, the continuity of gradients allows computations without using the values of b(r) at other values of r. c(r) only leads to an additive constant in the objective function, and so plays no role.

The system solves min _{β}f_{λ}(β)=f₀(β)+λ∥β∥₁ where \hat{f}₀(β)=μ/2β^{T}Kβ+Σᵢ₌₁ⁿi(rᵢ). The gradient, ĝ and the Hessian, Ĥ of \hat{f}₀ are given by ĝ(β)=μKβ+Σᵢ[a(rᵢ)rᵢ+b(rᵢ)]tᵢxᵢ, H(β)=μK+Σᵢa(rᵢ)xᵢxᵢ^{T}. The following should be noted: at β=0 , r=0 and so ĝ(0)=−Σᵢ0.5tᵢxᵢ; and, the change, δĝ corresponding to a change δβ in β, assuming that no crossing of knot points occur during the change, is given by δĝ=μKδβ+Σᵢa(rᵢ)δrᵢtᵢxᵢ=Hδβ.

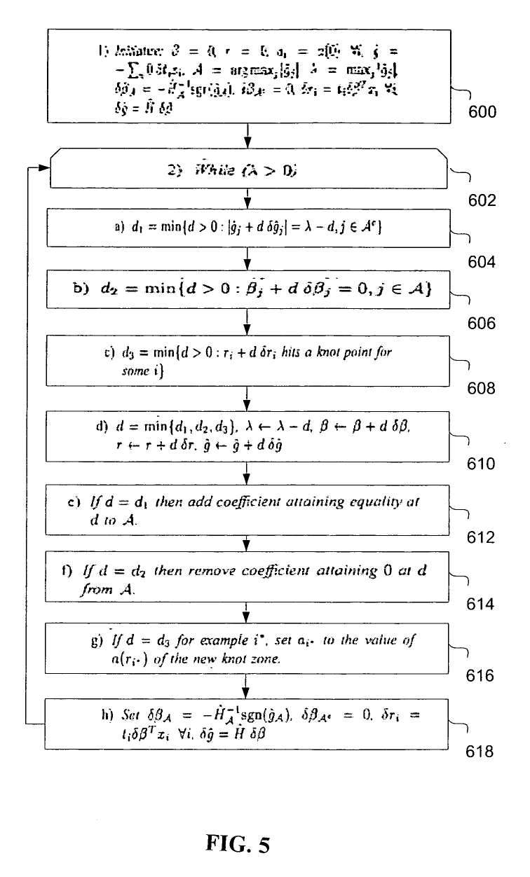

The tracking algorithm is now applied. Let A={j: βⱼ≠0} and A^{c} be the complement set of A. The following notations are used for a vector ν: νA with the vector of size |A| containing νⱼ. j ∈ A. For νⱼ≠0 ∀j, sgn(ν) is the vector containing the signs of ν. For a symmetric matrix X, X_{A} denotes the |A|−|A| matrix obtained by keeping only the rows and columns of X corresponding to A. Preferably, ĝ_{A}+λ sgn(β_{A})=0 and |ĝⱼ|≦λ∀j ∈ A^{c}. The first set of equalities define a piecewise linear path for β. Tracking them (typically by decreasing λ) yields a part of the full solution path. In one embodiment, this tracking occurs until one of the following events occurs: (a) a j ∈ A^{c} gives |ĝⱼ=λ, which means that the coefficient corresponding to j has to leave A^{c} and enter A; (b) a j ∈ A has βⱼ=0, which means that j leaves A and goes to A^{c}; and, (c) for a training example index i, rᵢ hits a knot point, which means that i(rᵢ) is switched from one quadratic model to another. The algorithm starts from β=0 and repeatedly applies the above methods to track the entire path. With reference to FIG. 5, the full algorithm is illustrated in a flow diagram. The steps in the method that implement the algorithm include:
1) Initialize: β=0. r=0. aᵢ=a(0) ∀i, ĝ=−Σ, 0.5tᵢxᵢ. A=arg maxⱼ|ĝⱼ|, λ=maxⱼ|ĝⱼ|. δβ_{A}=−Ĥ_{A}⁻¹sgn(ĝ_{A}), δβ_{A}_{^{c}}=0, δrᵢ=tᵢδβ^{T}xᵢ ∀i, δĝ=Ĥ δβ. step 600.
2) While (λ>0) step 602
   a) d₁=min{d>0: |ĝⱼ+d δĝⱼ=λ−d,j ∈ A^{c}), step 604
   b) d₂=min{d>0: βⱼ+d \overline{o}βⱼ=0,j ∈ A} step 606
   c) d₃=min{d>0: rᵢ+d δrᵢ hits a knot point for some i} step 608
   d) d=min{d₁,d₂,d₃}. λ←λ−d. β←β+d δβ. r←r+d δr. ĝ←ĝ+\overline{o}ĝ step 610
   e) If d=d₁ then add coefficient attaining equality at d to A. step 612
   f) If d=d₂ then remove coefficient attaining 0 at d from A. step 614
   g) If d=d₃ for example iⁿ, set aᵢ− to the value of a(rᵢ−) of the new knot zone. step 616
   h) Set δβ_{A}=−Ĥ_{A}⁻¹sgn(ĝ_{A}). δβ_{A′}=0. δrᵢ=tᵢδβ^{T} xᵢ ∀i. δĝ=Ĥ δβ step 618

Since Ĥ_{A}⁻¹ is required in steps 600 and 618, it is useful to maintain and update a Cholesky decomposition of Ĥ_{A}. Changes caused by steps 612, 614 and 616 lead to changes in Ĥ_{A}. The corresponding changes to the Cholesky decomposition can be performed. If the number of knot points, (2k+1) is large, then the algorithm will pass through step 608 many times, causing the method to become expensive in terms of processing time.

The embodiment that uses LARS corresponds to leaving out steps 606 and 614. In that embodiment, coefficients entering A never leave it. Thus, it is simpler to implement. The LASSO embodiments and LARS embodiments produce nearly the same paths.

The use of the path obtained from the embodiment using the LARS method is discussed next. If it is assumed that the “knot crossing” events occur 0(n) times, then every iteration of the above described method needs 0(mn) effort (for steps 604 through 610) and 0(m²) effort for step 618. Hence, 0(m+n) iterations of the method uses O(mn²) effort if m>n.

### Pseudo-Newton Correction Process

The path described in the above is already a good approximation of the true path corresponding to logistic regression. However, the quadratic approximation of the loss function is not interpretable as negative log-likelihood. Thus, one embodiment provides an approximation more closely to the true path, which is performed by applying a correction process. In this embodiment, let λ_{b} and λₐ be the λ values at two consecutive runs of steps 604-618 in FIG. 5. In the interval, (λₐ,λ_{b}), let A denote the set of non-zero coefficients. For most applications it is usually sufficient to obtain a precise solution just at the midpoint, λ=(λₐ+λ_{b})/2.

In the correction process, at the given λ, the approximate path is used first to obtain the initial solution, β⁰. Let s_{A}=sgn(ĝ_{A}(β⁰)). For the LARS embodiment, the following nonlinear system is solved,
g_{A}=λs_{A} (5)

where g_{A} is the gradient of f₀ in equation 3 and is given by

$${g}_{} = μ {K}_{} {{β}_{}}_{} - {\sum }_{i}^{} \frac{exp ( - {r}_{i} )}{1 + exp ( - {r}_{i} )} {t}_{i} {x}_{} \qquad ( 6 )$$

Applying Newton's method on equation 6 is expensive in terms of processing since it involves the repeated determination of the Hessian of f₀ and its inverse. Instead, a fixed matrix is used, \overline{H}_{A}, that is an approximation of the Hessian, and the following pseudo-Newton iterations are performed:
β^{t+1}_{A}=β^{t}_{A}−\overline{H}^{-t}_{A}g_{A}, t≧0 (7)

The least expensive choice for \overline{H}_{A} (in terms of processing use) is Ĥ_{A}, the Hessian of \hat{f}₀, which (together with its Cholesky factorization) is available as a by-product of the approximate tracking algorithm discussed above. Using the tolerance, ε=10⁻³, the system terminates the iterations in equation 7 when

$$\frac{1}{\vert \vert} ‖ {g}_{} - λ {s}_{} ‖ \leq ελ \qquad ( 8 )$$

In another embodiment, an alternative construction for \overline{H}_{A} is used that shows better convergence properties on equation 7. In this embodiment, the exact Hessian of f₀ with respect to β_{A} is given by H_{A}=μK_{A}+Σᵢω(rᵢ)x_{Ai}x^{T}_{Ai} where

$$w ( {r}_{i} ) = \frac{exp ( - {r}_{i} )}{{( 1 + exp ( - {r}_{i} ) )}^{2}} .$$

While doing the approximate tracking algorithm described above, it is usually the case that, in the initial stage when the key coefficients are picked up, the rᵢ experiences a lot of change. However, after the important coefficients get picked up, the rᵢ (and therefore, the w(rᵢ)) undergo only small changes. With this in mind, w(rᵢ) values can be fixed at one stage of the algorithm, and used to define \overline{H}_{A}. For a given choice of ω ∈ Rⁿ, the following is defined

$${\tilde{H}}_{} = μ {K}_{} + {\sum }_{i}^{} {w}_{i} {x}_{ i} {x}_{ i}^{T} \qquad ( 9 )$$

In the beginning of the approximate tracking algorithm (step 600 in FIG. 5) the system sets ωᵢ=0.25 ∀i and computes \overline{H} (by equation 9) and also its factorization (which is just a square root operation since there is only one coefficient). At each pass through Step 612 of FIG. 6, \overline{H}_{A} is updated to one higher dimension using the wᵢ. Whenever the correction process is required at some λ, for example, at the mid-point of an interval, (λₐ,λ_{b}), the system uses the current approximation \overline{H}_{A} and applies the pseudo-Newton iterations in equation 7. A maximum of tₘₐₓ iterations is allowed where tₘₐₓ=max{100, |A|/100}.

If the iterations do not converge within those many iterations, that is most likely an indication that the wᵢ that have been used are outdated. In this case the system computes them fresh as wᵢ=w(rᵢ), using the current values of rᵢ, and re-computes \overline{H}_{A} using equation 9. The system also newly performs the Cholesky factorization of \overline{H}. This process is quite efficient. Non-convergence of equation 7 within tₘₐₓ iterations (which prompts the complete re-determination of \tilde{H} and its factorization) takes place only occasionally and so the whole process is efficient.

For the LASSO version, during the application of equation 7, a LASSO optimality condition could be violated, e.g., a βᵢ^{t}, i ∈ A changes sign. Such occurrences are rare. However, in one embodiment, additional processing provides for LASSO optimality.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for tracking the solution curve of sparse logistic regression, comprising:
approximating a logistic regression loss function by a piece-wise quadratic function;
tracking a piecewise linear solution curve corresponding to the piece-wise quadratic function; and
applying a correction algorithm to obtain a true path for the logistic regression loss function.

2. The method of claim 1, wherein the step of tracking uses Rosset and Zhu's path tracking method.

3. The method of claim 1, wherein the sparse logistic regression is used to classify text documents.

4. The method of claim 3, wherein the text documents include web page documents classified for an internet search engine.

5. The method of claim 1, wherein the tracking step is applied to a kernel logistic regression.

6. The method of claim 1, wherein the correction algorithm comprises a pseudo-Newton correction process.

7. A system for tracking the solution curve of sparse logistic regression, comprising:
a computer usable medium having computer readable program code embodied therein configured for rendering an image interactive from the point of view of a user comprising:
computer readable code configured to approximate a logistic regression loss function by a piece-wise quadratic function;
computer readable code configured to track a piecewise linear solution curve corresponding to the piece-wise quadratic function; and
computer readable code configured to apply a correction algorithm to obtain a true path for the logistic regression loss function.

8. The system claim 7, wherein the computer readable code configured to track uses Rosset and Zhu's path tracking method.

9. The system of claim 7, wherein the sparse logistic regression is configured to be used to classify text documents.

10. The system of claim 9, wherein the text documents include web page documents classified for an internet search engine.

11. The system of claim 7, wherein the computer readable code configured to track is applied to kernel logistic regression.

12. The system of claim 7, wherein the correction algorithm comprises a pseudo-Newton correction process.

13. A computer program product stored on a computer-readable medium having instructions for tracking the solution curve of sparse logistic regression, comprising:
approximating a logistic regression loss function by a piece-wise quadratic function;
tracking a piecewise linear solution curve corresponding to the piece-wise quadratic function; and
applying a correction algorithm to obtain a true path for the logistic regression loss function.
